(19) United States
(12) Patent Application Publication
(10) Pub. No.: US 2018/0316599 A1
(43) Pub. Date: Nov. 1, 2018

(54) ROUTING PACKETS CONSIDERING THE PROPAGATION DELAY OF ROUTES

(71) Applicant: Hewlett Packard Enterprise Development LP, Houston, TX (US)

(72) Inventor: Nicholas George McDonald, Fort Collins, CO (US)

(21) Appl. No.: 15/498,890

(22) Filed: Apr. 27, 2017

(51) Int. Cl. H04L 12/727; H04L 12/733; H04L 12/729; H04L 12/751

(52) U.S. Cl. CPC H04L 45/121; H04L 45/02; H04L 45/125; H04L 45/122

(57) ABSTRACT

Examples relate to routing packets considering the propagation delay of candidate routes in a network. A packet is received at a network device in a network and a plurality of weighted candidate routes for the packet to be received at a destination device are determined. Each candidate route is associated to a weight based on a propagation delay of the candidate route. An optimal route is selected among the plurality of weighted candidate routes and the packet is routed to the destination device using the optimal route.

### BACKGROUND

A routing algorithm is a set of step-by-step operations used to direct data traffic through a network efficiently. When a packet of data leaves its source, there are many different paths it can take to its destination. The routing algorithm may be used to determine the best path to take. Different routing algorithms may use different methods to determine the best path. For example, a distance vector algorithm may calculate a graph of all available routes by having each routing point (called a node in the network) determine the “cost” or “weight” of travelling to each of its immediate neighbors. This information may be collected for every node to create a distance table which may be used to determine the best path to take from any one node to another.

### BRIEF DESCRIPTION OF THE DRAWINGS

FIG. 1 is a flowchart of an example method for routing packets considering the propagation delay of weighted candidate routes.

FIG. 2 is a flowchart of another example method for routing packets considering the hop count to the destination device and the propagation delay and congestion of the weighted candidate routes.

FIG. 3 is a block diagram of an example network with a plurality of network devices wherein packets are routed considering the propagation delay of weighted candidate routes and including a detailed view of one of the network devices of the network.

FIG. 4 is a block diagram of an example network device for routing packets considering the propagation delay of weighted candidate routes and including a machine-readable storage medium that stores instructions to be executed by a routing engine of the network device.

### DETAILED DESCRIPTION

Routing algorithms may use a weighted decision based on congestion and hop count (e.g., Universal Globally Adaptive Load-Balancing (UGAL)) to route data packets through nodes in a network. These routing algorithms may estimate the expected remaining delay in routing the data packets by multiplying the hop count and congestion of the network and choose the route that yields the lowest weight, which approximates the lowest delay between the source node and the destination node. The source node can be considered to be the node where the packet is created or the node where the packet currently exists and routing is being performed. The routing algorithms may generally assume that channel lengths of all possible routes between the source node and the destination node in a network are equal. However, this assumption may be untrue, especially in large scale networks in which channel lengths are high enough to introduce significant propagation delays, and may result in inefficient routing choices.

The congestion of the network may refer to the delay sending a packet from a source node to a destination node due to existing data traffic in the route followed by the packet. For example, the congestion may comprise the queue occupancy of the output or egress ports of network devices in the network, for example a network device such as a router or a switch, through which packets are going to be forwarded to the destination node. In such examples, the egress ports may comprise a buffer, for example a First-In-First-Out (FIFO) buffer or a ring buffer, to temporarily store data to be forwarded to a neighbor node. In turn, the hop count may refer to the number of intermediate network devices (nodes) through which data is to pass between the source network device and destination network device (source node and destination node) in the network. Each network device along a data path (route) for packets between the source node and the destination node may constitute a hop, as the data is moved from one network device to another. Hop count may be therefore a measurement of a logical distance in a network.

As generally described herein, propagation delay may refer to the amount of time it takes for a packet to travel from the source node to the destination node in a network. In some examples, the propagation delay may be computed as the ratio between the path length (route length) and the propagation speed over a specific channel. The propagation delay may depend on various parameters, including, for example, characteristics of the network channel or link between the source and the destination nodes such as channel latency, channel length, channel bandwidth, and so on. In general, propagation delay may include any latency that is a fixed delay through a particular route.

Weighted decision routing algorithms do not consider the propagation delay in their calculations. This can lead to unnecessary high latencies delivering packets from a source node to a destination node because packets may cross long latency routes when other routes with low latency may be available. For example, considering a case where a routing algorithm is deciding between two routes with 2 hops each and the same congestion in the respective routes, the routing algorithm may equally choose between these two routes. However, one of the routes may have two short channels and the other route may have two very long channels. The choice of the route having the two very long channels may yield to undesirable high latency transmissions through the network.

To address these issues, some examples disclosed herein describe methods for routing packets considering the propagation delay of routes. These methods may comprise receiving a packet at a network device in a network, for example in a network device such as a router or a switch. Then a routing engine of the network device may determine a plurality of candidate routes for the packet to a destination device. As generally described herein, a routing engine may represent a combination of hardware and software logic in a network device for determining candidate routes for a packet to take from a source device to a destination device. Each of these candidate routes may be associated to a weight that is based on a propagation delay of the candidate route. Thus, the weight associated to a particular candidate route considers the amount of time it takes for the received packet to travel from the network device to the destination device through the particular candidate route. Then, the routing engine may select an optimal route among the plurality of weighted candidate routes and route the packet to the destination device using the selected optimal route.

In some examples, the routing engine may determine all possible candidate routes between the source network device and the destination device and calculate a weight associated to each candidate route. The routing engine may determine all possible candidate routes by, for example, using a pre-existing routing table in the network device or by performing arithmetic operations, for example using fixed function logic in the network device. Further, in some other examples, the weight associated to each candidate route may be calculated, by the routing engine, based on a combination of a number of hops of the candidate route, a congestion along the candidate route and the propagation delay associated to the candidate route. In such examples, the candidate routes are associated to a weight that considers the latency introduced by the network into the packet transmission between the source network device and the destination network device, said latency being due to the links and the network devices in the routes through which a packet passes until reaching the destination network device.

In some examples, the weight of a particular candidate route may be calculated by multiplying the number of hops of the particular candidate route and the congestion along the particular candidate route and adding the propagation delay associated to the particular candidate route. In some other examples, the weight associated to a particular candidate route may be calculated by multiplying the number of hops of the particular candidate route and the congestion along the particular candidate route and adding a bias and the propagation delay associated to the particular candidate route. In such example the bias is a heuristically determined value added to the weight of non-minimal candidate routes to create prejudge against taking routes with higher hop counts. Biasing the weights of non-minimal candidate routes has been used to overcome the inaccuracy of the UGAL latency approximation assumptions.

In some examples, selecting the optimal route among the plurality of weighted candidate routes comprises selecting, by the routing engine, the optimal route as the weighted candidate route having the lowest estimated latency. This optimal route may minimize the delay of delivering the packet from the source network device to the destination network device considering the latency due to the links and the network devices between the source and the destination network devices in the route. Thus, the route with the minimum weight may be the route having the minimum latency to deliver packets from the source network device to the destination network device.

In some examples, each of the network devices in the network may store a routing table that lists the routes to particular network destinations, and in some cases, metrics (distances) associated with those routes. The routing table of a particular network device may further contain information about the topology of the network immediately around the particular network device. These routing tables may be automatically and dynamically generated by each network device by “discovering” procedures, or may be periodically provided by a network controller to each one of the network devices of the network. In both cases, any change in the network topology may automatically trigger an updating process in the routing tables in all network devices of the network. The routing tables may further store the propagation delays and weights associated to the routes.

In some other examples, the routing tables may be indexed with an identifier of the destination network device to determine which output port the packet should take. In some other examples, these routing tables may store different information fields such as the destination network device identifier, the cost or metric of the path through which the packet is to be sent and the next hop that is the address of the next node to which the packet is to be sent on the way to its final destination. In some other examples, the routing table may further store quality of service associated with the route links to filtering criteria/access lists associated with the route and an interface for each route.

In some other examples, the network devices may avoid the routing tables by arithmetically calculating the routes, metrics, propagation delays and weights associated to the routes when a packet is received in the destination network device.

In some other examples, the method may calculate the propagation delay associated to each channel based on channel parameters selected from channel latency, channel length, channel bandwidth or a combination thereof. For example, high performance low diameter networks have channel lengths that can vary by multiple orders of magnitude which may introduce different propagation delays.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

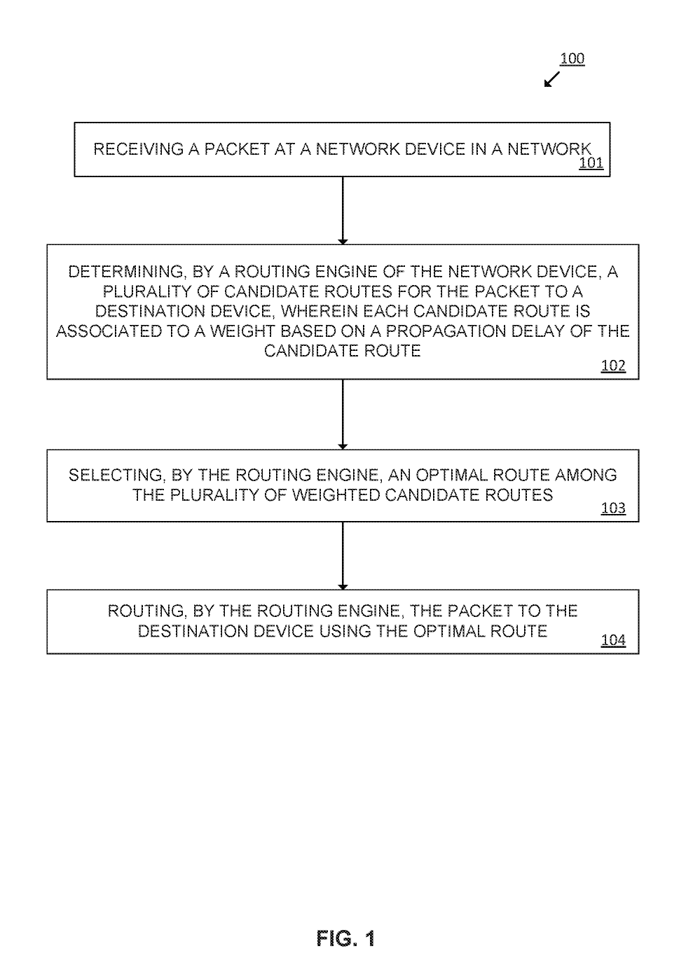

Turning now to the figures, FIG. 1 shows a flowchart of an example method 100 for routing packets considering propagation delay of optimal routes. Implementation of this method 100 is not limited to such example.

At step 101 of the method 100, a particular packet of data is received in a particular network device, for example a network device such as a switch or router, in a particular network.

At step 102 of the method 100, a routing engine of the particular network device determines a plurality of candidate routes for the packet to be received at a destination device. Each candidate route is associated to a weight that is calculated based on a propagation delay of the candidate route. This particular destination network device may be another network device from the same particular network, an edge device of another network to which the particular network is connected or any other device external to the network. In some examples, the routing engine may calculate all the possible candidate routes between the network device and the destination device and then calculate a weight associated to each candidate route. In some other examples, the routing engine may calculate a subset of candidate routes among all the possible candidate routes between the network device and the destination device. These candidate routes may be any possible routes connecting the current network device with the destination network device.

For example, the routing engine may calculate the propagation delay of the candidate routes based on channel parameters selected from channel latency, channel length, channel bandwidth or a combination thereof. In an example, a Serializer/Deserializer (SerDes) device may train links between network devices in the network and a round trip latency could be known from this process. From the round trip latency a one-direction channel latency can be obtained. The routing engine may then obtain channel latencies from a SerDes device. In some other examples, the routing engine may obtain the channel latency, channel length and channel bandwidth from known network information like the cables that got installed in the network.

At step 103 of the method 100, the routing engine selects the optimal route among the plurality of weighted candidate routes. In some examples, the routing engine may select the optimal route as the weighted candidate route having the lowest estimated latency to the destination device considering the latency due to the links and the network devices in the route.

Lastly, at step 104 of the method 100, the routing engine routes the packet to the destination network device using the selected optimal route. In this way, the expected latency computation of the optimal route includes the propagation delay such that the delay estimation includes the delay due to queues in the egress ports of network devices in the route and the delay due to channels of the route.

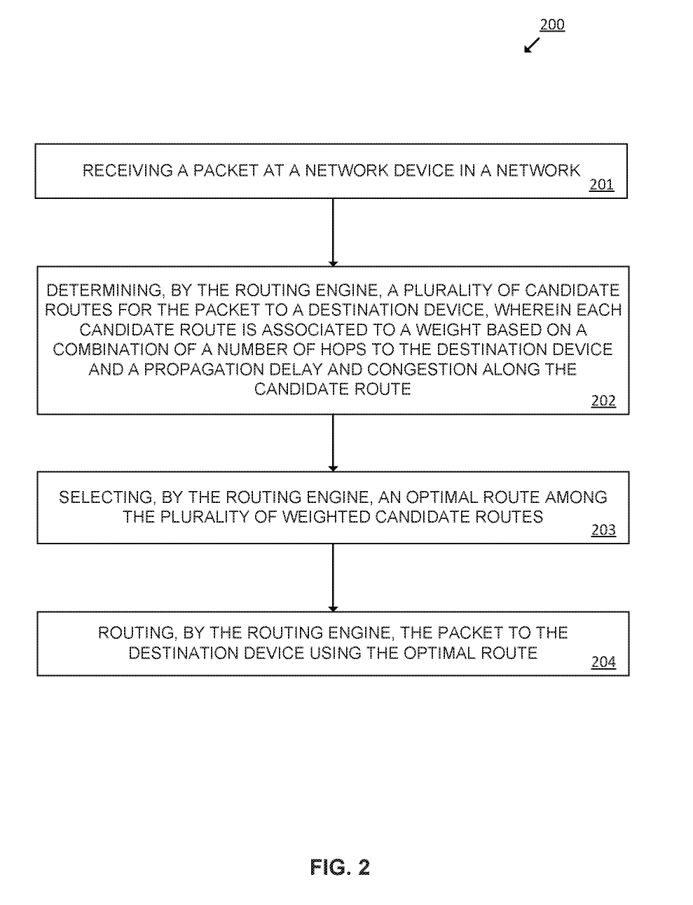

FIG. 2 is a flowchart of another example method 200 for routing packets considering the hop count to a destination device and the propagation delay and congestion of the candidate routes. Implementation of this method 200 is not limited to such example.

At step 201 of the method 200, a particular packet of data is received in a particular network device, for example a network device such as a switch or router, in a particular network.

At step 202 of the method 200, a routing engine of the particular network device determines a plurality of candidate routes for the packet to be received at a destination device. These candidate routes may be any possible route connecting the network device receiving the packet with the destination network device. Each candidate route is associated to a weight that is calculated by multiplying the congestion in the candidate route with the hop count of the candidate route and then adding the propagation delay from the current network device to the destination network device along the candidate route. The propagation delay associated to a route is the amount of time it takes for a packet to travel from the current network device to the destination network device. This propagation delay may be associated with the speed of data transmission on the channels and the fixed latency devices within the network devices through which the packet passes. The congestion along a candidate route may be obtained by multiple ways, for example, the routing engine may obtain the congestion based on queue occupancy along the candidate route, by comparing ingoing and outgoing rates of a particular route, be explicitly told by a specific software, etc.

For example, a packet arrives at a particular network device and there are two candidate routes, candidate route A and candidate route B, for the packet to the destination device. Then, the routing engine may calculate a corresponding weight for the routes. Candidate route A may have 4 hops, a 50% congestion and 100 ns propagation delay, such that the routing engine may calculate a weight associated to candidate route A as W_{A}=450+100=300. Candidate route B may have 3 hops, a 40% congestion and 10 ns propagation delay, such that the routing engine may calculate a weight associated to candidate route B as W_{B}=3*40+120=240. W_{A} and W_{B} incorporate latency due to the links and the network devices in the respective candidate routes A and B.

At step 203 of the method 200, the routing engine selects the optimal route among the plurality of weighted candidate routes. In some examples, the routing engine may select the optimal route as the weighted candidate route having a lowest weight. In the above cited example, the routing engine may select route B because W_{B}<W_{A} and thus, the total latency of candidate route B is less than the total latency of candidate route A.

At step 204 of the method 200, the routing engine routes the packet to the destination network device using the selected optimal route. In the above cited example, the routing engine routes the packet through candidate route B. This candidate route B is the route, among the possible candidate routes between the source network device and the destination network device, having the minimum latency delivering packets to the destination node.

In some other examples, the weight associated to the candidate routes may further include a bias for non-minimal routes. In such cases, the weight may be calculated by multiplying the congestion in the candidate route with the hop count of the candidate route and then adding the bias (if the route is non-minimal) and the propagation delay from the source network device to the destination network device along the candidate route. For example the bias may be 7 for non-minimal routes. In such example, the weight associated to candidate route A is W_{A}=4*50+7+100=307 (+7 because it is a non-minimal route) and the weight associated to candidate route B is W_{B}=3′40+120=240 (lack of +7 because it is a minimal route). Then, the routing engine may select the optimal route as the weighted candidate route having a lowest weight. In the cited example, the routing engine may select route B because W_{B}<W_{A} and thus, the total latency of candidate route B is less than the total latency of candidate route A.

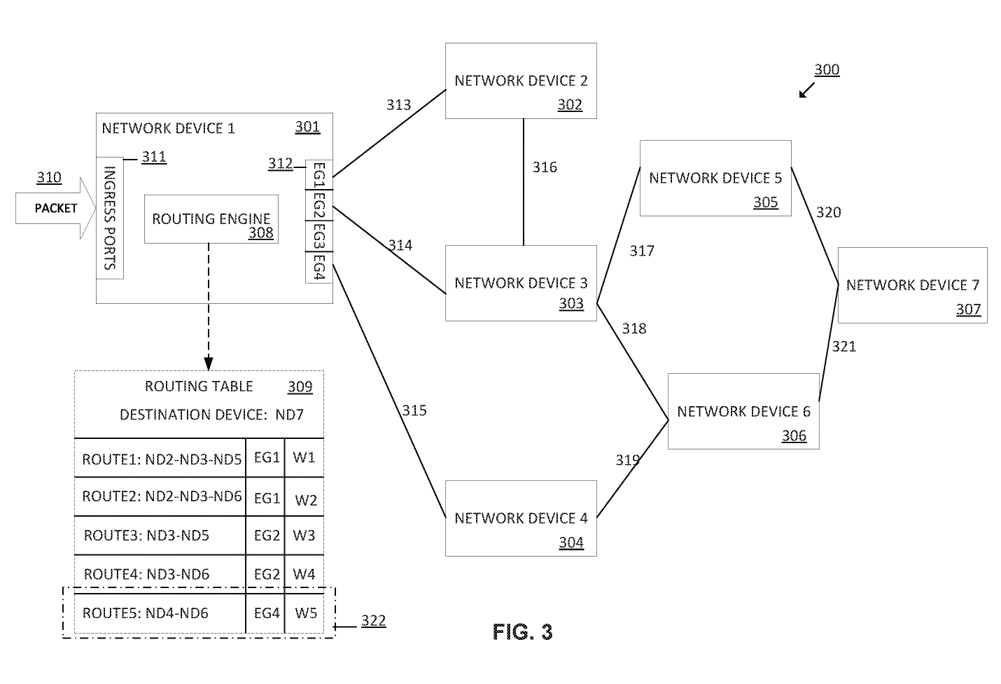

FIG. 3 is a block diagram of an example network 300 with a plurality of network devices in which packets 310 are routed considering the propagation delay of routes, including a detailed view of one of the network devices 301 in the network 300. It should be understood that the system 300 depicted in FIG. 3 may include additional components and that some of the components described herein may be removed and/or modified without departing from a scope of the example system 300. Additionally, implementation of system 300 is not limited to such example.

The network 300 comprises a network device 301 in which packets 310 of data are received. The network 300 further comprises network devices 302-307 that can be a destination for the packet 310 if the packet is directed to the network device 302-307, or a routing network device if the packet 310 is directed to another network device. Network devices 301-307 may be for example routers or switches. While FIG. 3 depicts a network 300 having 7 network devices 301-307, the network 300 may comprise any other number of network devices.

In the example of FIG. 3, network device 301 has routing engine 308, which may be a set of routing engine 308 in network device 301 accesses a routing table 309 storing all routes between network device 301 and each one of network devices 302-307. Each route has associated an egress port 312 and a weight. The weight of a particular route is calculated by the routing engine 308 by multiplying the number of hops of the particular route and the congestion along the particular route and adding the propagation delay associated to the particular route.

The packet 310 may be decoded by the routing engine 308 to extract the identifier of the destination network device. In such example the destination network device is network device 307 so the routing engine 308 selects a subset of candidate routes from the routing table 309 as shown in FIG. 3. The subset of candidate routes comprises a route1 corresponding to the route passing through network devices 302→303→305, a route2 corresponding to the route passing through network devices 302→303→306, a route3 corresponding to the route passing through network devices 303→305, a route4 corresponding to the route passing through network devices 303→306 and a route5 corresponding to the route passing through network devices 304→306. Each route from the subset of routes has an associated egress port. In particular, route1 and route2 have egress port1 (EG1) as the port to be used by the packets using these routes. Route3 and route4 have egress port2 (EG2) as the associated egress port and route5 has egress port4 (EG4) as the associated egress port.

In addition, each candidate route has a weight associated with it. Route1 has weight1 (W1) that corresponds to the result of multiplying the number of hops of route1 (hops 302,303,305) and the congestion along route1 (due existing data traffic in route1) and adding the propagation delay associated to the route1 (due to links 313,316,317,320 and network devices 302,303,305). Route2 has weight2 (W2) that corresponds to the result of multiplying the number of hops of route2 (hops 302,303,306) and the congestion along route2 (due existing data traffic in route2) and adding the propagation delay associated to the route2 (due to links 313,316,318,321 and network devices 302,303,306). Route3 has weight3 (W3) that corresponds to the result of multiplying the number of hops of route3 (hops 303,305) and the congestion along route3 (due existing data traffic in route3) and adding the propagation delay associated to the route3 (due to links 314,317,320 and network devices 303,305). Route4 has weight4 (W4) that corresponds to the result of multiplying the number of hops of route4 (hops 303,306) and the congestion along route4 (due existing data traffic in route4) and adding the propagation delay associated to the route4 (due to links 314,318,321 and network devices 303,306). Route5 has weight5 (W5) that corresponds to the result of multiplying the number of hops of route5 (hops 304,306) and the congestion along route5 (due existing data traffic in route5) and adding the propagation delay associated to the route5 (due to links 315,319,321 and network devices 304,306).

The routing engine 308 determines that the route5 322 has the minimum weight among the 5 candidate routes and selects it to forward the packet to network device 307. Therefore, the routing engine 308 forwards the received packet 310 to the network device through egress port 4 and along route5.

In examples including high performance networks within a single administrative domain, the propagation delay from any node to another node may correspond to cable lengths that in turn may be known explicitly or implicitly. For example, when a SerDes device trains a link, a round trip latency could be known from this process. The routing engine may obtain channel latencies from a SerDes device or from known system information like the cables that got installed. In examples including low diameter networks such as HyperX, Dragonfly, and Slimfly the propagation delays along different paths can vary by multiple orders of magnitude, for example between 1 ns to 500 ns.

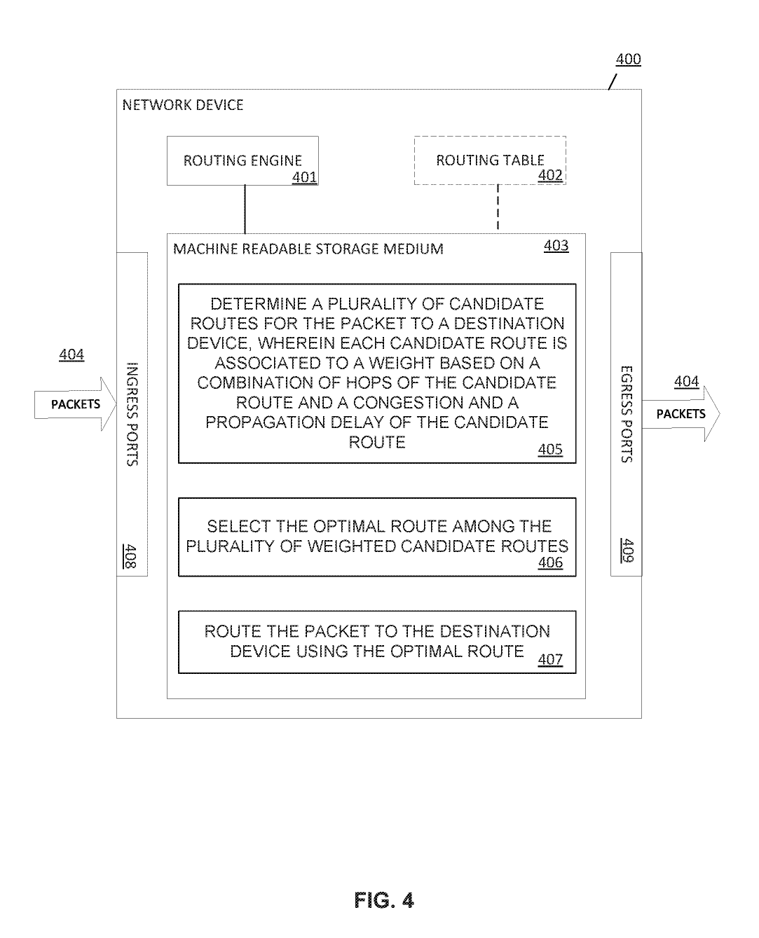

FIG. 4 is a block diagram of an example network device 400 for routing packets 404 considering the propagation delay of optimal routes in which a machine-readable storage medium 403 stores instructions to be executed by a processing resource of the routing engine 401. It should be understood that the network device 400 depicted in FIG. 4 may include additional components and that some of the components described herein may be removed and/or modified without departing from a scope of the example network device 400. Additionally, implementation of network device 400 is not limited to such example. It should also be understood that routing engine 401 may represent a combination of hardware and software logic in network device 400 for determining candidate routes for a packet to take from a source device to a destination device.

The network device 400 is depicted as including a plurality of ingress ports 408 through which packets 404 of data are received, a plurality of egress ports 409 through which packets 404 are forwarded towards their destination network devices, a machine readable storage medium 403, a routing engine 401 and a routing table 402. The routing engine 401 may include hardware and software logic to execute instructions, such as the instructions 405-407 stored in the machine-readable storage medium 403. While FIG. 4 shows a network device 400 comprising a routing table 402, the network device 400 may avoid having the routing table 402 by using arithmetic operations to dynamically calculate routes, metrics, weights and propagation delays when a packet is received in the network device 400 and temporarily storing this information in an internal memory (not shown in the figure). In some examples, the routing table 402 may store all the possible routes between the current network device and the rest of network devices in the network.

The routing engine 401, in response to reception of a packet 402 via the ingress ports 408 of the network device 400, determines at 405 a plurality of candidate routes for the packet 404 to a destination device, wherein each candidate route is associated to a weight based on a combination of a number of hops of the candidate route, a congestion along the candidate route and a propagation delay of the candidate route.

In examples where the routing table 402 stores all the possible routes between the current network device 400 and the rest of network devices in the network, the routing engine 401 may decode the received packet 404 to extract an identifier of the destination network device to which the packet is to be routed. Then, the routing engine 401 may select, based on the identifier of the destination network, the routes between the current network device 400 and the destination device among all the routes stored in the routing table 402.

The routing engine 401 further selects at 406 the optimal route among the plurality of weighted candidate routes. Then, the routing engine 401 further routes at 407 the packet 404 to the destination device using the optimal route. For example, the routing engine 401 may select the optimal route as the candidate route having a lowest weight.

In some other examples, the routing engine 401 may also calculate a weight associated to each candidate route by multiplying a number of hops of the weighted candidate route and a congestion along the weighted candidate route and adding the propagation delay associated to the weighted candidate route. The route having the minimum weight is the route that introduces a minimum delay in the transmission of packet 404. The weights and the propagation delays associated to each weighted candidate route may be further stored in the routing table 402.

The routing engine 401 may include hardware and software logic to perform the functionalities described above in relation to instructions 405-407. The machine-readable storage medium 403 may be located either in the computing device executing the machine-readable instructions, or remote from but accessible to the computing device (e.g., via a computer network) for execution.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory. In examples described herein, a machine-readable storage medium or media may be part of an article (or article of manufacture). An article or article of manufacture may refer to any manufactured single component or multiple components.

Routing packets considering propagation delay of candidate routes as described herein achieves many technical effects, including providing a more accurate packet delivery process that yields a significant improvement of network services, reducing average packet delivery latency by choosing between paths with respect to propagation delay. In addition, the solution herein described also may be useful to overcome problems experienced by many systems where choosing between minimal and non-minimal routes on an unloaded system may result in falsely choosing the non-minimal routes because the congestion is reported as zero and thus the weight becomes zero. In those cases, since the calculated weights also consider the propagation delay, the solution herein proposed allows to select the optimal route as the route having a lowest propagation delay, and thus the lowest estimated latency.

What is claimed is:

1. A method, comprising:
receiving a packet at a network device in a network;
determining, by a routing engine of the network device, a plurality of candidate routes for the packet to be received at a destination device, wherein each candidate route is associated to a weight based on a propagation delay of the candidate route;
selecting, by the routing engine, an optimal route among the plurality of weighted candidate routes; and
routing, by the routing engine, the packet to the destination device using the optimal route.

2. The method of claim 1, wherein the weight associated to each candidate route is calculated based on a combination of a number of hops of the candidate route, a congestion along the candidate route and the propagation delay of the candidate route.

3. The method of claim 2, wherein the weight of each candidate route is calculated by multiplying the number of hops of the candidate route and the congestion along the candidate route and adding the propagation delay of the candidate route.

4. The method of claim 1, wherein selecting the optimal route among the plurality of weighted candidate routes comprises selecting, by the routing engine, the optimal route as the weighted candidate route having a lowest estimated latency.

5. The method of claim 1, comprising storing, by the routing engine, the propagation delay associated to each candidate route in a routing table in the network device.

6. The method of claim 1, comprising storing, by the routing engine, the weight associated to each weighted candidate route in a routing table in the network device.

7. The method of claim 1, wherein determining a plurality of weighted candidate routes for the packet to be received at a destination device comprises determining all candidate routes between the network device and the destination device and calculating the weight associated to each candidate route.

8. The method of claim 1, comprising calculating, by the routing engine, the propagation delay associated to the optimal route based on channel parameters selected from channel latency, channel length, channel bandwidth or a combination thereof.

9. A non-transitory machine readable storage medium comprising instructions executable by a routing engine of a network device to:
in response to reception of a packet in the network device, determine a plurality of candidate routes for the packet to a destination device, wherein each candidate route is associated to a weight based on a combination of a number of hops of the candidate route, a congestion along the candidate route and a propagation delay of the candidate route;
select an optimal route among the plurality of weighted candidate routes; and
route the packet to the destination device using the optimal route.

10. The non-transitory machine readable storage medium of claim 9, wherein the instructions to determine the plurality of weighted candidate routes comprise further instructions to calculate the weight associated to each candidate route by multiplying the number of hops of the candidate route and the congestion along the candidate route and adding the propagation delay of the candidate route.

11. The non-transitory machine readable storage medium of claim 9, wherein the instructions to select the optimal route among the plurality of weighted candidate routes comprise further instructions to select the optimal route as the weighted candidate route having a lowest estimated latency.

12. The non-transitory machine readable storage medium of claim 9, comprising instructions to store the propagation delay associated to each candidate route in a routing table in the network device.

13. The non-transitory machine readable storage medium of claim 9, comprising instructions to store the weight associated to each weighted candidate route in a routing table in the network device.

14. The non-transitory machine readable storage medium of claim 9, comprising instructions to calculate the propagation delay associated to a candidate route based on channel parameters selected from channel latency, channel length, channel bandwidth or a combination thereof.

15. A network device comprising:
at least one ingress port through which a packet is received;
at least one egress port through which the packet is forwarded to a destination device; and
a routing engine to determine a plurality of candidate routes for the packet to be received at a destination device, wherein each candidate route is associated to a weight based on a propagation delay of the candidate route, select an optimal route among the plurality of weighted candidate routes and route the packet to the destination device using the optimal route.

16. The network device of claim 15, wherein the routing engine is to calculate the weight associated to each candidate route based on a combination of a number of hops of the candidate route, a congestion along the candidate route and the propagation delay of the candidate route.

17. The network device of claim 16, wherein the routing engine is to calculate the weight associated to each candidate route by multiplying the number of hops of the candidate route and the congestion along the candidate route and adding the propagation delay of the candidate route.

18. The network device of claim 15, wherein the routing engine is to select the optimal route as the weighted candidate route having a lowest estimated latency.

19. The network device of claim 15, comprising a routing table to store the propagation delay associated to each candidate route.

20. The network device of claim 15, comprising a routing table to store the weight associated to each weighted candidate route.
